(19) United States
(12) Patent Application Publication
(10) Pub. No.: US 2013/0201360 A1
(43) Pub. Date: Aug. 8, 2013

(54) METHOD OF CHANGING AN OPERATION MODE OF A CAMERA IMAGE SENSOR

(71) Applicant: Samsung Electronics Co., Ltd., Suwon-Si (KR)

(72) Inventor: Yong-Bae SONG, Seoul (KR)

(73) Assignee: SAMSUNG ELECTRONICS CO., LTD., Suwon-Si (KR)

(21) Appl. No.: 13/668,442

(22) Filed: Nov. 5, 2012

(30) Foreign Application Priority Data
Feb. 3, 2012 (KR) 10-2012-0011380

(51) Int. Cl. H04N 5/228

(52) U.S. Cl. 348/222.1; 348/E05.031

(57) ABSTRACT

By a method of changing an operation mode of a camera image sensor, an application processor outputs a resolution change request signal to the camera image sensor when an operation mode change signal is generated while the camera image sensor outputs a first sensor output image. The camera image sensor prepares a resolution change operation in response to the resolution change request signal, outputs an interrupt signal to the application processor when the resolution change operation is prepared, performs the resolution change operation after the first sensor output image is output, and outputs a second sensor output image when the resolution change operation is completed. The application processor changes an interface setting value in response to the interrupt signal, and receives the second sensor output image based on the changed interface setting value.

### CROSS-REFERENCE TO RELATED APPLICATION(S)

This application claims priority under 35 USC §119 to Korean Patent Applications No. 10-2012-0011380, filed on Feb. 3, 2012 in the Korean Intellectual Property Office (KIPO), the contents of which are incorporated herein in their entirety by reference.

### BACKGROUND

1. Technical Field

Example embodiments relate generally to changing an operation mode of a camera image sensor included in a camera module.

2. Description of the Related Art

Recently, some electric devices (e.g., mobile devices) include a camera module according to a mobile convergence trend. In the camera module, a camera image sensor may operate in a preview mode for a user to watch an image in real-time, or may operate in a capture preparation mode for a user to capture an image. That is, the camera image sensor may reduce power consumption by outputting a sensor output image having a low resolution in a preview mode, and may obtain an image having a user setting capture size by outputting a sensor output image having a high resolution in a capture preparation mode. However, conventional camera image sensor may have a time period during which an image capture operation cannot be performed when the conventional camera image sensor changes a resolution of the sensor output image between a low resolution and a high resolution (i.e., changes an operation mode between the preview mode and the capture preparation mode). Thus, a user may be aware of the time period during which the image capture operation cannot be performed when the sensor output image output from the conventional camera image sensor is displayed on a display panel. As a result, the user may recognize a resolution change (or, a size change) of the sensor output image output from the conventional camera image sensor.

### SUMMARY

Some example embodiments provide a method of changing an operation mode of a camera image sensor capable of preventing a user from recognizing a resolution change (or, a size change) of the sensor output image output from the camera image sensor when an operation mode of the camera image sensor is changed.

According to some example embodiments, a method of changing an operation mode of a camera image sensor may include a step of controlling an application processor to output a resolution change request signal to the camera image sensor when an operation mode change signal is generated while the camera image sensor outputs a first sensor output image, a step of controlling the camera image sensor to prepare a resolution change operation in response to the resolution change request signal, to output an interrupt signal to the application processor when the resolution change operation is prepared, to perform the resolution change operation after the first sensor output image at a time point when the resolution change operation is prepared is completely output, and to output a second sensor output image when the resolution change operation is completed, and a step of controlling the application processor to change an interface setting value in response to the interrupt signal, and to receive the second sensor output image based on the changed interface setting value.

In example embodiments, the resolution change request signal may be transmitted based on inter-integrated circuit (I2C) interface.

In example embodiments, the first sensor output image and the second sensor output image may be transmitted based on MIPI interface, ITU-R BT.601 interface, ITU-R BT.656 interface, or ITU-R BT.709 interface.

In example embodiments, the first sensor output image may correspond to a sensor output image having a low resolution, and the second sensor output image may correspond to a sensor output image having a high resolution.

In example embodiments, a size of the first sensor output image may correspond to a display output size, and the size of the first sensor output image may be changed as the display output size is changed.

In example embodiments, a size of the second sensor output image may correspond to a reference or, alternatively, a predetermined size, and the size of the second sensor output image may be changed by a user.

In example embodiments, the application processor may receive the first sensor output image in a preview mode of the camera image sensor, and the application processor may receive the second sensor output image in a capture preparation mode of the camera image sensor.

In example embodiments, the operation mode change signal may correspond to an auto-focus start signal for performing a focusing operation.

In example embodiments, the operation mode change signal may correspond to a smile detection signal for performing a smile detecting operation.

In example embodiments, the operation mode change signal may correspond to a face detection signal for performing a face detecting operation.

In example embodiments, the operation mode change signal may correspond to a first external input signal for changing the operation mode of the camera image sensor from the preview mode to the capture preparation mode.

In example embodiments, the first sensor output image may correspond to a sensor output image having a high resolution, and the second sensor output image may correspond to a sensor output image having a low resolution.

In example embodiments, a size of the first sensor output image may correspond to a reference or, alternatively, a predetermined size, and the size of the first sensor output image may be changed by a user.

In example embodiments, a size of the second sensor output image may correspond to a display output size, and the size of the second sensor output image may be changed as the display output size is changed.

In example embodiments, the application processor may receive the first sensor output image in a capture preparation mode of the camera image sensor, and the application processor may receive the second sensor output image in a preview mode of the camera image sensor.

In example embodiments, the operation mode change signal may correspond to a capture completion signal for indicating that an image capture operation of the first sensor output image is completed.

In example embodiments, the operation mode change signal may correspond to a second external input signal for changing the operation mode of the camera image sensor from the capture preparation mode to the preview mode.

Therefore, a method of changing an operation mode of a camera image sensor according to example embodiments may prevent a user from recognizing a resolution change (or, a size change) of the sensor output image output from the camera image sensor by accurately changing an interface setting value between an application processor (AP) and the camera image sensor (CIS) at a reference or, alternatively, a predetermined time point.

According to at least one example embodiment, a method of changing an operation mode of a camera image sensor in a camera module including the camera sensor and an application processor, may include generating an operation mode change signal while the camera image sensor outputs a first image having a first resolution; outputting a resolution change request signal from the application processor to the camera image sensor in response to the operation mode change signal; changing a resolution of the camera image sensor from the first resolution to a second resolution in response to the resolution change request signal, the second resolution being higher than the first resolution; outputting an interrupt signal and a second image having the second resolution from the camera image sensor to the application processor; and receiving the second image at the application processor based on the interrupt signal.

According to at least one example embodiment, the method may further include changing an interface value at the application processor based on the interrupt signal, and the receiving the second image at the application processor may include switching from receiving the first image to receiving the second image based on the interface value.

According to at least one example embodiment, the generating the operation mode change signal may include generating the operation mode change signal based on at least one of an autofocus operation, a smile detection operation, and a face detection operation.

### BRIEF DESCRIPTION OF THE DRAWINGS

The above and other features and advantages of example embodiments will become more apparent by describing in detail example embodiments with reference to the attached drawings. The accompanying drawings are intended to depict example embodiments and should not be interpreted to limit the intended scope of the claims. The accompanying drawings are not to be considered as drawn to scale unless explicitly noted.

FIG. 1 is a flow chart illustrating a method of changing an operation mode of a camera image sensor according to example embodiments.

FIG. 2 is a diagram illustrating an operation that is performed between a camera image sensor and an application processor by a method of FIG. 1.

FIG. 3 is a diagram illustrating an example in which an operation is performed between a camera image sensor and an application processor by a method of FIG. 1.

FIG. 4 is a diagram illustrating another example in which an operation is performed between a camera image sensor and an application processor by a method of FIG. 1.

FIG. 5 is a conceptual diagram illustrating an operation mode of a camera image sensor that is changed by a method of FIG. 1.

FIG. 6 is a timing diagram illustrating an operation mode of a camera image sensor that is changed by a method of FIG. 1.

FIG. 7 is a block diagram illustrating a mobile device employing a method of changing an operation mode of a camera image sensor according to example embodiments.

FIG. 8 is a block diagram illustrating an example of a camera image sensor included in a mobile device of FIG. 7.

FIG. 9 is a block diagram illustrating an example of an application processor included in a mobile device of FIG. 7.

FIG. 10 is a diagram illustrating an example in which a mobile device of FIG. 7 is implemented as a smart-phone.

FIG. 11 is a block diagram illustrating an electric device employing a method of changing an operation mode of a camera image sensor according to example embodiments.

FIG. 12 is a block diagram illustrating an example of an interface used for an electric device of FIG. 11.

### DETAILED DESCRIPTION OF THE EMBODIMENTS

Detailed example embodiments are disclosed herein. However, specific structural and functional details disclosed herein are merely representative for purposes of describing example embodiments. Example embodiments may, however, be embodied in many alternate forms and should not be construed as limited to only the embodiments set forth herein. Accordingly, while example embodiments are capable of various modifications and alternative forms, embodiments thereof are shown by way of example in the drawings and will herein be described in detail. It should be understood, however, that there is no intent to limit example embodiments to the particular forms disclosed, but to the contrary, example embodiments are to cover all modifications, equivalents, and alternatives falling within the scope of example embodiments. Like numbers refer to like elements throughout the description of the figures.

It will be understood that, although the terms first, second, etc. may be used herein to describe various elements, these elements should not be limited by these terms. These terms are only used to distinguish one element from another. For example, a first element could be termed a second element, and, similarly, a second element could be termed a first element, without departing from the scope of example embodiments. As used herein, the term “and/or” includes any and all combinations of one or more of the associated listed items.

It will be understood that when an element is referred to as being “connected” or “coupled” to another element, it may be directly connected or coupled to the other element or intervening elements may be present. In contrast, when an element is referred to as being “directly connected” or “directly coupled” to another element, there are no intervening elements present. Other words used to describe the relationship between elements should be interpreted in a like fashion (e.g., “between” versus “directly between”, “adjacent” versus “directly adjacent”, etc.).The terminology used herein is for the purpose of describing particular embodiments only and is not intended to be limiting of example embodiments. As used herein, the singular forms “a”, “an” and “the” are intended to include the plural forms as well, unless the context clearly indicates otherwise. It will be further understood that the terms “comprises”, “comprising,”, “includes” and/or “including”, when used herein, specify the presence of stated features, integers, steps, operations, elements, and/or components, but do not preclude the presence or addition of one or more other features, integers, steps, operations, elements, components, and/or groups thereof.

It should also be noted that in some alternative implementations, the functions/acts noted may occur out of the order noted in the figures. For example, two figures shown in succession may in fact be executed substantially concurrently or may sometimes be executed in the reverse order, depending upon the functionality/acts involved. Unless otherwise defined, all terms (including technical and scientific terms) used herein have the same meaning as commonly understood by one of ordinary skill in the art to which example embodiments belong. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

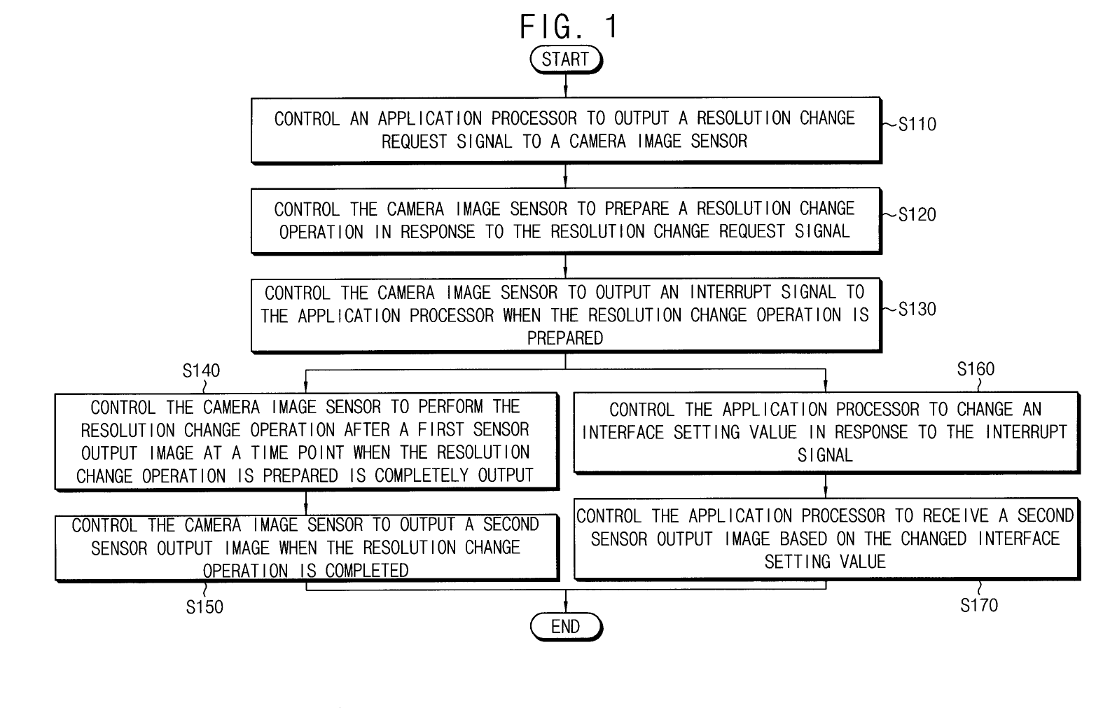

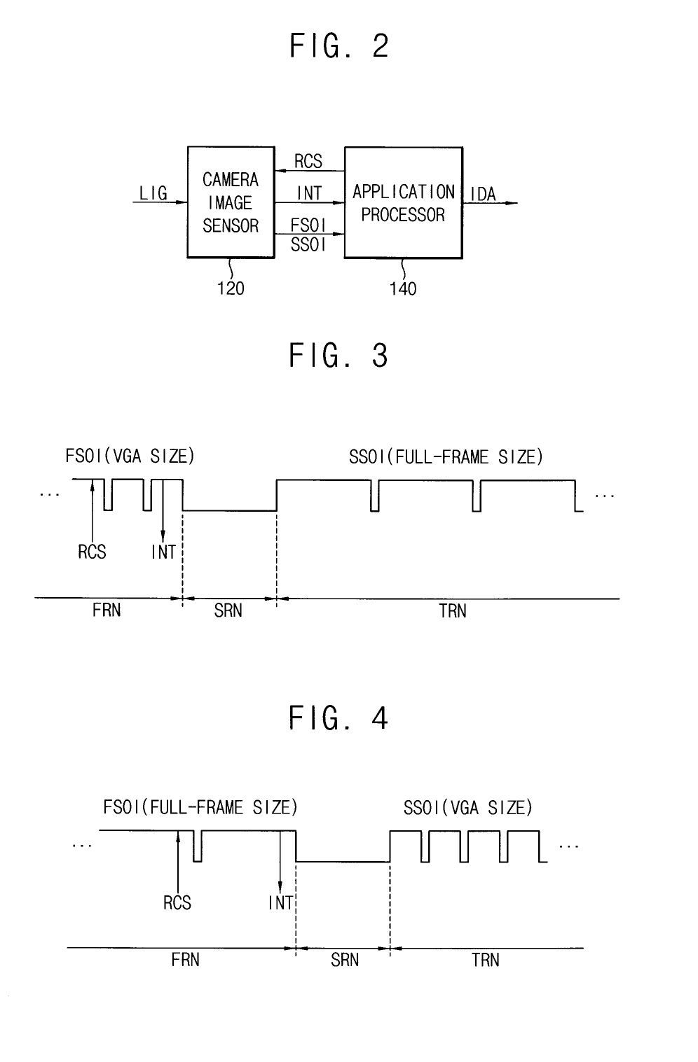

FIG. 1 is a flow chart illustrating a method of changing an operation mode of a camera image sensor according to example embodiments. FIG. 2 is a diagram illustrating an operation that is performed between a camera image sensor and an application processor by a method of FIG. 1.

Referring to FIGS. 1 and 2, the method of FIG. 1 may control the application processor 140 to output a resolution change request signal RCS to the camera image sensor 120 (Step S110) when an operation mode change signal is generated while the camera image sensor 120 outputs a first sensor output image FSOI. Then, the method of FIG. 1 may control the camera image sensor 120 to prepare a resolution change operation in response to the resolution change request signal RCS (Step S120), to output an interrupt signal INT to the application processor 140 when the resolution change operation is prepared (Step S130), to perform the resolution change operation after the first sensor output image FSOI at a time point when the resolution change operation is prepared is completely output (Step S140), and to output a second sensor output image SSOI when the resolution change operation is completed (Step S150). Here, the method of FIG. 1 may control the application processor 140 to change an interface setting value in response to the interrupt signal INT (Step S160), and to receive the second sensor output image SSOI based on the changed interface setting value (Step S170).

Recently, a mobile device mostly includes a camera module according to a mobile convergence trend. In the camera module, the camera image sensor 120 may operate in a preview mode for a user to watch an image LIG in real-time, or may operate in a capture preparation mode for a user to capture an image LIG. To reduce unnecessary power consumption, a sensor output image may be set to have a low resolution in the preview mode of the camera image sensor 120, and a sensor output image may be set to have a high resolution in the capture preparation mode of the camera image sensor 120. Thus, the preview mode of the camera image sensor 120 may be referred to as a low resolution preview mode, and the capture preparation mode of the camera image sensor 120 may be referred to as a high resolution preview mode. However, conventional camera image sensor may have a time period during which an image capture operation cannot be performed (i.e., a capture disable period) when the conventional camera image sensor changes an operation mode between the preview mode and the capture preparation mode based on a shutter signal. The capture disable period may cause a shutter-lag in a camera module, and may cause a user to recognize a resolution change (i.e., a size change) of the sensor output image output from the conventional camera image sensor. In addition, an image capture operation may be performed by the conventional camera image sensor although a resolution of the sensor output image is inconsistent with an interface setting value of an application processor. In this case, abnormal data is written in a memory device so that the abnormal data may be displayed on a display device as an image data IDA. As a result, a user may consider this as malfunction.

To solve these problems, the method of FIG. 1 may control the application processor 140 to output the resolution change request signal RCS to the camera image sensor 120 (Step S110) when the operation mode change signal is generated while the camera image sensor 120 outputs the first sensor output image FSOI. In one example embodiment, the resolution change request signal may be transmitted based on inter-integrated circuit (I2C) interface. In detail, when the method of FIG. 1 changes an operation mode of the camera image sensor 120 from the preview mode to the capture preparation mode, the first sensor output image FSOI may correspond to a sensor output image having a low resolution, and the second sensor output image SSOI may correspond to a sensor output image having a high resolution. Here, a size of the first sensor output image FSOI may correspond to a display output size. Thus, a size of the first sensor output image FSOI may be changed as the display output size is changed. For example, a size of the first sensor output image FSOI may be a VGA (640*480) size. On the other hand, a size of the second sensor output image SSOI may correspond to a reference or, alternatively, a predetermined size. Thus, a size of the second sensor output image SSOI may be changed by a user. For example, a size of the second sensor output image SSOI may be a full-frame size (e.g., 5M (2608*1960), 8M (3264*2448), etc). That is, the application processor 140 may receive a sensor output image having a low resolution (i.e., the first sensor output image FSOI) in the preview mode of the camera image sensor 120, and the application processor 120 may receive a sensor output image having a high resolution (i.e., the second sensor output image SSOI) in the capture preparation mode of the camera image sensor 120. In this case, the operation mode change signal may be at least one of an auto-focus start signal for performing a focusing operation, a smile detection signal for performing a smile detecting operation, a face detection signal for performing a face detecting operation, and a first external input signal (e.g., a touch input signal, a button input signal, a sound input signal, etc) for changing an operation mode of the camera image sensor 120 from the preview mode to the capture preparation mode.

On the other hand, when the method of FIG. 1 changes an operation mode of the camera image sensor 120 from the capture preparation mode to the preview mode, the first sensor output image FSOI may correspond to a sensor output image having a high resolution, and the second sensor output image SSOI may correspond to a sensor output image having a low resolution. Here, a size of the first sensor output image FSOI may correspond to a reference or, alternatively, a predetermined size. Thus, a size of the first sensor output image FSOI may be changed by a user. For example, a size of the first sensor output image FSOI may be a full-frame size (e.g., 5M (2608*1960), 8M (3264*2448), etc). On the other hand, a size of the second sensor output image SSOI may correspond to a display output size. Thus, a size of the second sensor output image SSOI may be changed as the display output size is changed. For example, a size of the second sensor output image SSOI may be a VGA (640*480) size. Thus, a size of the second sensor output image SSOI may be changed by a user. For example, a size of the second sensor output image SSOI may be a full-frame size (e.g., 5M (2608*1960), 8M (3264*2448), etc). That is, the application processor 140 may receive a sensor output image having a high resolution (i.e., the first sensor output image FSOI) in the capture preparation mode of the camera image sensor 120, and the application processor 120 may receive a sensor output image having a low resolution (i.e., the second sensor output image SSOI) in the preview mode of the camera image sensor 120. In this case, the operation mode change signal may be at least one of a capture completion signal for indicating that an image capture operation of the first sensor output image FSOI is completed and a second external input signal (e.g., a touch input signal, a button input signal, a sound input signal, etc) for changing an operation mode of the camera image sensor 120 from the capture preparation mode to the preview mode. Here, it should be understood that a “resolution” of a sensor output image is a term including a “pixel” of the sensor output image, a “size” of the sensor output image, a “capacity” of the sensor output image, a “sampling rate” of the sensor output image, etc. In addition, although it is described that the resolution change request signal RCS is transmitted based on I2C interface, it is not limited thereto. Thus, an interface for transmitting the resolution change request signal may be variously determined.

Then, the method of FIG. 1 may control the camera image sensor 120 to prepare the resolution change operation in response to the resolution change request signal RCS (Step S120), to output the interrupt signal INT to the application processor 140 (Step S130) when the resolution change operation is prepared, to perform the resolution change operation (Step S140) after the first sensor output image FSOI at a time point when the resolution change operation is prepared is completely output, and to output the second sensor output image SSOI (Step S150) when the resolution change operation is completed. Here, the first and second sensor output images FSOI and SSOI are transmitted from the camera image sensor 120 to the application processor 140 based on mobile industry processor interface (MIPI) interface, ITU-R BT.601 interface, ITU-R BT.656 interface, or ITU-R BT.709 interface. As described above, when the method of FIG. 1 changes an operation mode of the camera image sensor 120 from the preview mode to the capture preparation mode, the first sensor output image FSOI may correspond to a sensor output image having a low resolution, and the second sensor output image SSOI may correspond to a sensor output image having a high resolution. Thus, the application processor 140 may receive the first sensor output image FSOI from the camera image sensor 120 in the preview mode, and then may receive the second sensor output image SSOI from the camera image sensor 120 after an operation mode of the camera image sensor 120 is changed from the preview mode to the capture preparation mode. On the other hand, when the method of FIG. 1 changes an operation mode of the camera image sensor 120 from the capture preparation mode to the preview mode, the first sensor output image FSOI may correspond to a sensor output image having a high resolution, and the second sensor output image SSOI may correspond to a sensor output image having a low resolution. Thus, the application processor 140 may receive the first sensor output image FSOI from the camera image sensor 120 in the capture preparation mode, and then may receive the second sensor output image SSOI from the camera image sensor 120 after an operation mode of the camera image sensor 120 is changed from the capture preparation mode to the preview mode.

Here, the method of FIG. 1 may control the application processor 140 to change an interface setting value in response to the interrupt signal INT (Step S160), and to receive the second sensor output image SSOI based on the changed interface setting value (Step S170). That is, the application processor 140 may change an interface setting value when the interrupt signal INT is input from the camera image sensor 120. For this operation, it is desirable that a real-time response of the application processor 140 for the interrupt signal INT is guaranteed. Generally, an interface of the application processor 140 supports a frame unit operation. In one example embodiment, the application processor 140 may receive the first sensor output image FSOI at a time point when the resolution change operation is prepared (i.e., a current frame) based on an interface setting value, and may receive the second sensor output image SSOI (i.e., a next frame) based on the changed interface setting value after the first sensor output image FSOI is completely output. In another example embodiment, the application processor 140 may receive a reference or, alternatively, a predetermined number of sensor output images that includes the first sensor output image FSOI at a time point when the resolution change operation is prepared based on an interface setting value, and may receive the second sensor output image SSOI based on the changed interface setting value after the reference or, alternatively, a predetermined number of sensor output images are completely output. The application processor 140 may change an interface setting value while the camera image sensor 120 performs the resolution change operation. When the camera image sensor 120 outputs the second sensor output image SSOI after finishing (i.e., completing) the resolution change operation, the application processor 140 may receive the second sensor output image SSOI based on the changed interface setting value. As a result, an interface setting value between the application processor 140 and the camera image sensor 120 may be accurately changed at a reference or, alternatively, a predetermined time point. Thus, a user may not recognize a resolution change (i.e., a size change) of the sensor output image output from the camera image sensor 120. Although an image signal processor (ISP) is not illustrated in FIG. 2, the image signal processor may be coupled to the camera image sensor 120, or may be located inside the application processor 140.

FIG. 3 is a diagram illustrating an example in which an operation is performed between a camera image sensor and an application processor by a method of FIG. 1.

Referring to FIG. 3, it is illustrated that an operation of the camera image sensor 120 is changed from a preview mode to a capture preparation mode. A first period FRN indicates a period in which the camera image sensor 120 operates in the preview mode. A second period SRN indicates a transition period between the preview mode and the capture preparation mode. A third period TRN indicates a period in which the camera image sensor 120 operates in the capture preparation mode. In detail, when an operation mode change signal is generated while the camera image sensor 120 outputs a first sensor output image FSOI, the application processor 140 may output a resolution change request signal RCS to the camera image sensor 120. Here, the operation mode change signal may be at least one of an auto-focus start signal, a smile detection signal, a face detection signal, and a first external input signal (e.g., a touch input signal, a button input signal, a sound input signal, etc) for changing an operation mode of the camera image sensor 120 from the preview mode to the capture preparation mode. As illustrated in FIG. 3, the first sensor output image FSOI may be a VGA (640*480) size. Then, the camera image sensor 120 may prepare a resolution change operation in response to the resolution change request signal RCS output from the application processor 140, and may output an interrupt signal INT to the application processor 140 when the resolution change operation is prepared. Next, the camera image sensor 120 may perform the resolution change operation after the first sensor output image FSOI, at a time point when the resolution change operation is prepared, is completely output, and may output the second sensor output image SSOI after the resolution change operation is completed. At this time, the application processor 140 may change an interface setting value in response to the interrupt signal INT output from the camera image sensor 120, and may receive the second sensor output image SSOI based on the changed interface setting value.

Generally, an interface of the application processor 140 supports a frame unit operation. Hence, when an interface setting value of the application processor 140 is changed while the camera image sensor 120 outputs a specific frame, the application processor 140 may not receive the specific frame based on the changed interface setting value. Thus, an interface setting value between the application processor 140 and the camera image sensor 120 needs to be accurately changed at a reference or, alternatively, a predetermined time point. As illustrated in FIG. 3, the application processor 140 may receive the first sensor output image FSOI output from the camera image sensor 120 based on an interface setting value. That is, the application processor 140 may begin to change an interface setting value at a time point when the interrupt signal INT is output from the camera image sensor 120 (i.e., when the resolution change operation is prepared in the camera image sensor 120), and may finish changing an interface setting value before the camera image sensor 120 outputs the second sensor output image SSOI. In addition, the camera image sensor 120 may perform the resolution change operation after the first sensor output image FSOI at a time point when the interrupt signal INT is output from the camera image sensor 120 (i.e., at a time point when the resolution change operation is prepared) is completely output, and may output the second sensor output image SSOI after the resolution change operation is completed.

As a result, after the second period SRN (i.e., the transition period between the preview mode and the capture preparation mode, the camera image sensor 120 may output the second sensor output image SSOI in the third period TRN (i.e., the period in which the camera image sensor 120 operates in the capture preparation mode). Thus, the application processor 140 may also receive the second sensor output image SSOI based on the changed interface setting value in the third period TRN (i.e., the period in which the camera image sensor 120 operates in the capture preparation mode). As described above, the second sensor output image SSOI may be a full-frame size (e.g., 5M (2608*1960), 8M (3264*2448), etc). Meantime, the second period SRN (i.e., the transition period between the preview mode and the capture preparation mode) may be much shorter than the first period FRN and the third period TRN. Hence, a user may not recognize the second period SRN because the application processor 140 responds to the interrupt signal INT in real-time, and the camera image sensor 120 outputs one frame within a very short time. As a result, the method of FIG. 1 may prevent a user from recognizing a resolution change (i.e., a size change) of the sensor output image output from the camera image sensor 120.

In FIG. 3, it is illustrated that the application processor 140 receives the first sensor output image FSOI at a time point when the resolution change operation is prepared (i.e., a current frame) based on an interface setting value, and receives the second sensor output image SSOI (i.e., a next frame) based on the changed interface setting value after the first sensor output image FSOI is completely output. However, example embodiments are not limited thereto. For example, the application processor 140 may receive a reference or, alternatively, a predetermined number (e.g., two or three) of sensor output images that includes the first sensor output image FSOI at a time point when the resolution change operation is prepared based on an interface setting value, and may receive the second sensor output image SSOI based on the changed interface setting value after the reference or, alternatively, a predetermined number (e.g., two or three) of sensor output images are completely output.

FIG. 4 is a diagram illustrating another example in which an operation is performed between a camera image sensor and an application processor by a method of FIG. 1.

Referring to FIG. 4, it is illustrated that an operation mode of the camera image sensor 120 is changed from a capture preparation mode to a preview mode. A first period FRN indicates a period in which the camera image sensor 120 operates in the capture preparation mode. A second period SRN indicates a transition period between the capture preparation mode and the preview mode. A third period TRN indicates a period in which the camera image sensor 120 operates in the preview mode. In detail, when an operation mode change signal is generated while the camera image sensor 120 outputs a first sensor output image FSOI, the application processor 140 may output a resolution change request signal RCS to the camera image sensor 120. Here, the operation mode change signal may be at least one of a capture completion signal and a second external input signal (e.g., a touch input signal, a button input signal, a sound input signal, etc) for changing an operation mode of the camera image sensor 120 from the capture preparation mode to the preview mode. As illustrated in FIG. 4, the first sensor output image FSOI may be a full-frame size (e.g., 5M (2608*1960), 8M (3264*2448). Then, the camera image sensor 120 may prepare a resolution change operation in response to the resolution change request signal RCS output from the application processor 140, and may output an interrupt signal INT to the application processor 140 when the resolution change operation is prepared. Next, the camera image sensor 120 may perform the resolution change operation after the first sensor output image FSOI at a time point when the resolution change operation is prepared is completely output, and may output the second sensor output image SSOI after the resolution change operation is completed. At this time, the application processor 140 may change an interface setting value in response to the interrupt signal INT output from the camera image sensor 120, and may receive the second sensor output image SSOI based on the changed interface setting value.

Generally, an interface of the application processor 140 supports a frame unit operation. Hence, when an interface setting value of the application processor 140 is changed while the camera image sensor 120 outputs a specific frame, the application processor 140 may not receive the specific frame based on the changed interface setting value. Thus, an interface setting value between the application processor 140 and the camera image sensor 120 needs to be accurately changed at a reference or, alternatively, a predetermined time point. As illustrated in FIG. 4, the application processor 140 may receive the first sensor output image FSOI output from the camera image sensor 120 based on an interface setting value. That is, the application processor 140 may begin to change an interface setting value at a time point when the interrupt signal INT is output from the camera image sensor 120 (i.e., when the resolution change operation is prepared in the camera image sensor 120), and may finish changing an interface setting value before the camera image sensor 120 outputs the second sensor output image SSOI. In addition, the camera image sensor 120 may perform the resolution change operation after the first sensor output image FSOI at a time point when the interrupt signal INT is output from the camera image sensor 120 (i.e., at a time point when the resolution change operation is prepared) is completely output, and may output the second sensor output image SSOI after the resolution change operation is completed.

As a result, after the second period SRN (i.e., the transition period between the capture preparation mode and the preview mode, the camera image sensor 120 may output the second sensor output image SSOI in the third period TRN (i.e., the period in which the camera image sensor 120 operates in the preview mode). Thus, the application processor 140 may also receive the second sensor output image SSOI based on the changed interface setting value in the third period TRN (i.e., the period in which the camera image sensor 120 operates in the preview mode). As described above, the second sensor output image SSOI may be a VGA (640*480) size. Meantime, the preview mode of the camera image sensor 120 may be a default mode. Thus, the method of FIG. 1 may change an operation mode of the camera image sensor 120 from the capture preparation mode to the preview mode after an image capture operation is performed. Since power consumption of the preview mode is smaller than power consumption of the capture preparation mode, the method of FIG. 1 may reduce unnecessary power consumption by changing an operation mode of the camera image sensor 120 from the capture preparation mode to the preview mode after an image capture operation is performed. In addition, the second period SRN (i.e., the transition period between the capture preparation mode and the preview mode) may be much shorter than the first period FRN and the third period TRN. Hence, a user may not recognize the second period SRN because the application processor 140 responds to the interrupt signal INT in real-time, and the camera image sensor 120 outputs one frame within a very short time. As a result, the method of FIG. 1 may prevent a user from recognizing a resolution change (i.e., a size change) of the sensor output image output from the camera image sensor 120.

In FIG. 4, it is illustrated that the application processor 140 receives the first sensor output image FSOI at a time point when the resolution change operation is prepared (i.e., a current frame) based on an interface setting value, and receives the second sensor output image SSOI (i.e., a next frame) based on the changed interface setting value after the first sensor output image FSOI is completely output. However, example embodiments are not limited thereto. For example, the application processor 140 may receive a reference or, alternatively, a predetermined number (e.g., two or three) of sensor output images that includes the first sensor output image FSOI at a time point when the resolution change operation is prepared based on an interface setting value, and may receive the second sensor output image SSOI based on the changed interface setting value after the reference or, alternatively, a predetermined number (e.g., two or three) of sensor output images are completely output.

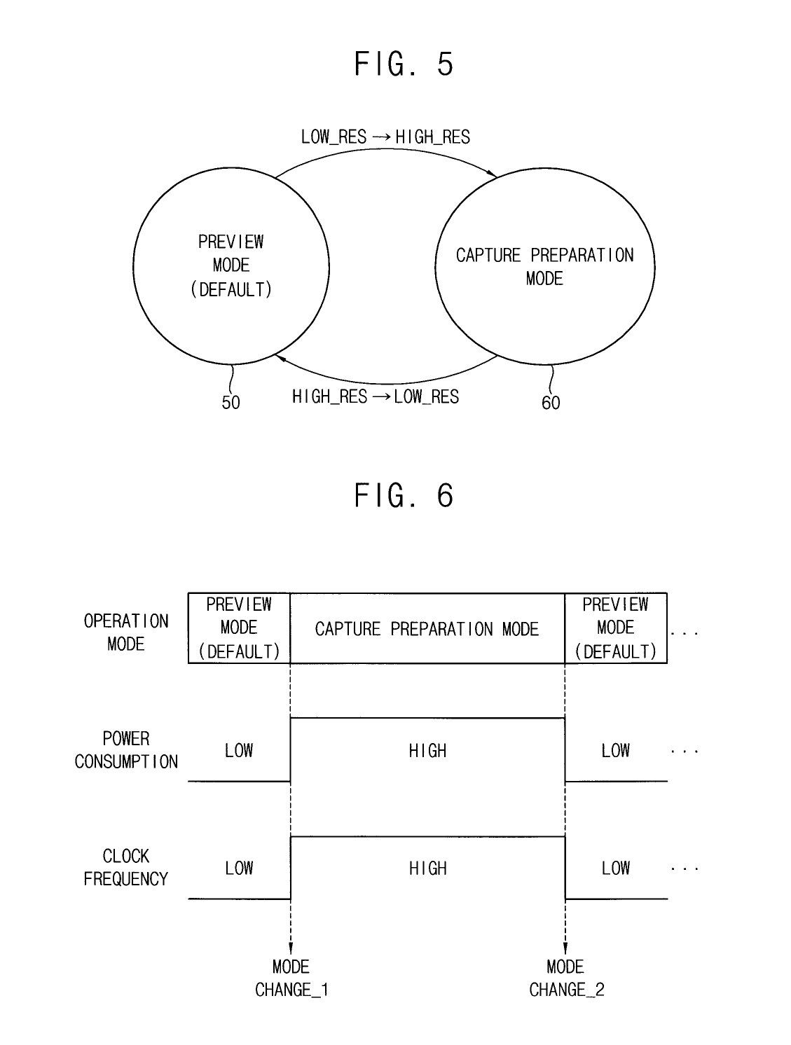

FIG. 5 is a conceptual diagram illustrating an operation mode of a camera image sensor that is changed by a method of FIG. 1.

Referring to FIG. 5, a camera image sensor 120 may operate in a preview mode 50 or a capture preparation mode 60. The preview mode 50 of the camera image sensor 120 indicates a mode for watching an image in real-time. The capture preparation mode 60 of the camera image sensor 120 indicates a mode for preparing an image capture. Here, in the capture preparation mode 60 of the camera image sensor 120, a user may watch an image before an image capture operation is performed (i.e., before a user triggers a shutter). However, a sensor output image may be maintained to have a low resolution in the preview mode 50 of the camera image sensor 120, and a sensor output image may be maintained to have a high resolution in the capture preparation mode 60 of the camera image sensor 120. For example, a size of the sensor output image having a low resolution may be a VGA (640*480) size, and a size of the sensor output image having a high resolution may be a full-frame size (e.g., 5M (2608*1960), 8M (3264*2448), etc). In conclusion, the method of FIG. 1 performs a mode change operation between the preview mode 50 and the capture preparation mode 60 for the camera image sensor 120. However, conventional camera image sensor may have a time period during which an image capture operation cannot be performed (i.e., a capture disable period) when the conventional camera image sensor changes an operation mode between the preview mode and the capture preparation mode. The capture disable period may cause a user to recognize a resolution change (i.e., a size change) of the sensor output image output from the conventional camera image sensor. To solve these problems, the method of FIG. 1 may prevent a user from recognizing a resolution change (i.e., a size change) of the sensor output image output from the camera image sensor 120 by accurately changing an interface setting value between the application processor 140 and the camera image sensor 120 at a reference or, alternatively, a predetermined time point. Since the method of FIG. 1 is described above, duplicated descriptions will be omitted.

In one example embodiment, the method of FIG. 1 may change an operation mode of the camera image sensor 120 from the preview mode 50 to the capture preparation mode 60. That is, a resolution of the sensor output image output from the camera image sensor 120 may be changed from a low resolution to a high resolution (i.e., LOW_RES→HIGH_RES). In detail, the method of FIG. 1 may change an operation mode of the camera image sensor 120 from the preview mode 50 to the capture preparation mode 60 based on an operation mode change signal, the operation mode change signal being generated while the camera image sensor 120 outputs a first sensor output image FSOI. The operation mode change signal may be at least one of an auto-focus start signal for performing a focusing operation, a smile detection signal for performing a smile detecting operation, a face detection signal for performing a face detecting operation, and a first external input signal (e.g., a touch input signal, a button input signal, a sound input signal, etc) for changing an operation mode of the camera image sensor 120 from the preview mode 50 to the capture preparation mode 60.

In another example embodiment, the method of FIG. 1 may change an operation mode of the camera image sensor 120 from the capture preparation mode 60 to the preview mode 50. That is, a resolution of the sensor output image output from the camera image sensor 120 may be changed from a high resolution to a low resolution (i.e., HIGH_RES→LOW_RES). In detail, the method of FIG. 1 may change an operation mode of the camera image sensor 120 from the capture preparation mode 60 to the preview mode 50 to the capture preparation mode 60 based on an operation mode change signal, the operation mode change signal being generated while the camera image sensor 120 outputs a first sensor output image FSOI. The operation mode change signal may be at least one of a capture completion signal for indicating that an image capture operation of the first sensor output image FSOI is completed and a second external input signal (e.g., a touch input signal, a button input signal, a sound input signal, etc) for changing an operation mode of the camera image sensor 120 from the capture preparation mode 60 to the preview mode 50. As described above, the preview mode 50 of the camera image sensor 120 may be a default mode. Thus, the method of FIG. 1 may reduce unnecessary power consumption by changing an operation mode of the camera image sensor 120 from the capture preparation mode 60 to the preview mode 50 after an image capture operation is performed.

FIG. 6 is a timing diagram illustrating an operation mode of a camera image sensor that is changed by a method of FIG. 1.

Referring to FIG. 6, the method of FIG. 1 may change an operation mode of the camera image sensor 120 between a preview mode and a capture preparation mode. Here, a first mode change MODE CHANGE_1 indicates that an operation mode of the camera image sensor 120 is changed from the preview mode to the capture preparation mode, and a second mode change MODE CHANGE_2 indicates that an operation mode of the camera image sensor 120 is changed from the capture preparation mode to the preview mode. As illustrated in FIG. 6, since the sensor output image is maintained to have a low resolution in the preview mode of the camera image sensor 120, a clock frequency for operating the camera image sensor 120 is relatively low, and power consumption for performing the preview mode is relatively low. On the other hand, since the sensor output image is maintained to have a high resolution in the capture preparation mode of the camera image sensor 120, a clock frequency for operating the camera image sensor 120 is relatively high, and power consumption for performing the capture preparation mode is relatively high. Thus, in order to reduce power consumption of the camera image sensor 120, it is desirable to minimize the capture preparation mode that consumes a relatively high power. Meantime, when an operation mode of the camera image sensor 120 is changed between the preview mode and the capture preparation mode, the method of FIG. 1 may prevent a user from recognizing a resolution change (i.e., a size change) of the sensor output image output from the camera image sensor 120 by accurately changing an interface setting value between the application processor 140 and the camera image sensor 120 at a reference or, alternatively, a predetermined time point.

In detail, the first mode change MODE CHANGE_1 may be performed by changing a resolution of the sensor output image from a low resolution to a high resolution in response to an operation mode change signal when the operation mode change signal is generated in the preview mode of the camera image sensor 120. For example, the operation mode change signal may be at least one of an auto-focus start signal for performing a focusing operation, a smile detection signal for performing a smile detecting operation, a face detection signal for performing a face detecting operation, and a first external input signal (e.g., a touch input signal, a button input signal, a sound input signal, etc) for changing an operation mode of the camera image sensor 120 from the preview mode to the capture preparation mode. The second mode change MODE CHANGE_2 may be performed by changing a resolution of the sensor output image from a high resolution to a low resolution in response to an operation mode change signal when the operation mode change signal is generated in the capture preparation mode of the camera image sensor 120. For example, the operation mode change signal may be at least one of a capture completion signal for indicating that an image capture operation is completed and a second external input signal (e.g., a touch input signal, a button input signal, a sound input signal, etc) for changing an operation mode of the camera image sensor 120 from the capture preparation mode to the preview mode. In conclusion, the method of FIG. 1 may prevent a user from recognizing a resolution change (i.e., a size change) of the sensor output image output from the camera image sensor 120, and may reduce unnecessary power consumption by changing an operation mode of the camera image sensor 120 from the capture preparation mode to the preview mode after an image capture operation is performed.

FIG. 7 is a block diagram illustrating a mobile device employing a method of changing an operation mode of a camera image sensor according to example embodiments.

Referring to FIG. 7, the mobile device 200 may include a camera image sensor 220, an application processor 240, and at least one display device 260. In some example embodiments, the mobile device 200 may further include a plurality of function circuits 280 for performing various functions for the mobile device 200. Here, the camera image sensor 220, the application processor 240, and the display device 260 may constitute a camera module included in the mobile device 200.

The mobile device 200 may perform various functions according to a mobile convergence trend. As illustrated in FIG. 7, the mobile device 200 may include the camera module (i.e., the camera image sensor 220, the application processor 240, and the display 260) for performing a camera function. The mobile device 200 may further include an image signal processor (ISP). For example, the image signal processor may be coupled to the camera image sensor 220, or the image signal processor may be located within the application processor 240. As described above, as the mobile device 200 has lower power consumption and smaller product size, the mobile device 200 may include the application processor 240 for performing various functions. Here, the mobile device 200 employs a method of changing an operation mode of a camera image sensor according to example embodiments. For example, according to at least one example embodiment, the camera image sensor 220 and application processor 240 may perform in the same manner as that described above with reference to the camera image sensor 120 and the application processor 140, respectively. By the method of changing an operation mode of the camera image sensor, an interface setting value between the camera image sensor 220 and the application processor 240 may be accurately changed at a reference or, alternatively, a predetermined time point. As a result, a user may not recognize a resolution change (i.e., a size change) of the sensor output image output from the camera image sensor 220. For this operation, the application processor 240 may output a resolution change request signal to the camera image sensor 220 when an operation mode change signal is generated while the camera image sensor 220 outputs a first sensor output image. Then, the camera image sensor 220 may prepare a resolution change operation in response to the resolution change request signal, may output an interrupt signal to the application processor 240 when the resolution change operation is prepared, may perform the resolution change operation after the first sensor output image at a time point when the resolution change operation is prepared is completely output, and may output a second sensor output image when the resolution change operation is completed. At this time, the application processor 240 may change an interface setting value in response to the interrupt signal, and may receive the second sensor output image based on the changed interface setting value.

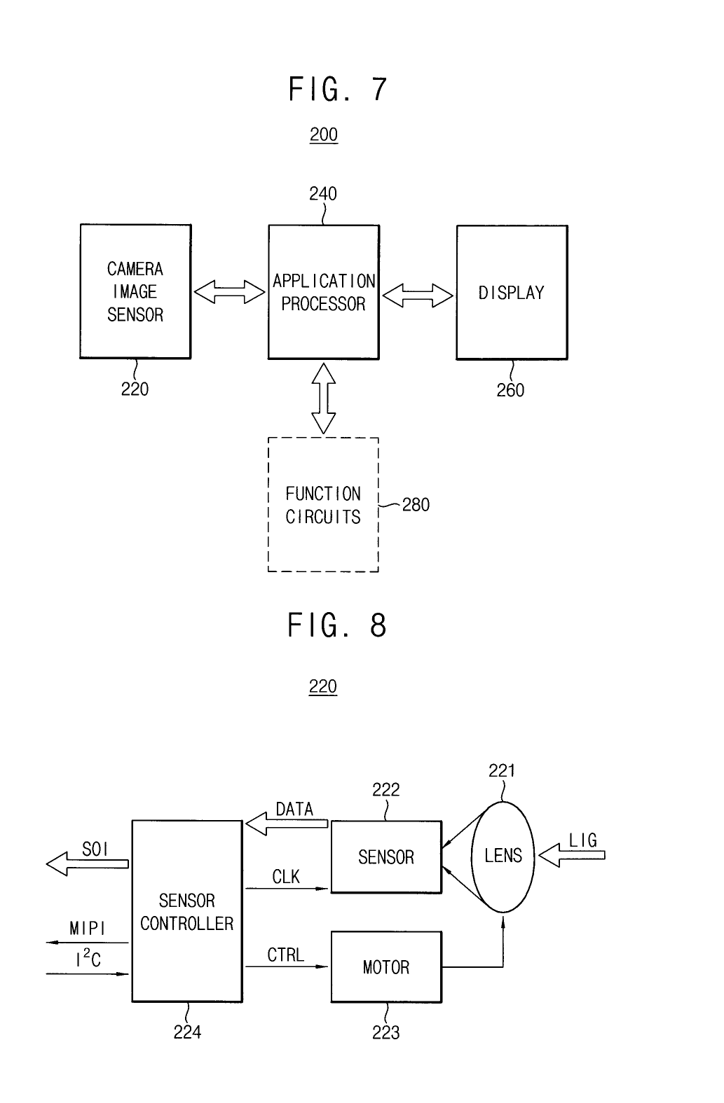

FIG. 8 is a block diagram illustrating an example of a camera image sensor included in a mobile device of FIG. 7.

Referring to FIG. 8, the camera image sensor 220 may include a lens 221, a sensor 222, a motor 223, and a sensor controller 224.

The camera image sensor 220 may generate a sensor output image SOI by receiving a light signal LIG corresponding to a subject for photography, and performing a photoelectric transformation based on the light signal LIG. In detail, the lens 221 may concentrate light (i.e., the light signal LIG) on light-receiving regions (e.g., a plurality of unit pixels included in a unit pixel array). The sensor 222 may generate data DATA having information of the subject for photography based on the light signal LIG input through the lens 221. In some example embodiments, the sensor 222 may be a Complementary Metal-Oxide Semiconductor (CMOS) sensor or a Charge Coupled Device (CCD) sensor. The sensor 222 may provide the data DATA to the sensor controller 224 based on a clock signal CLK. The motor 223 may perform a focusing operation or a shuttering operation of the lens 221 based on a control signal CTRL provided from the sensor controller 224. The sensor controller 224 may control the sensor 222 and the motor 223, and may process the data DATA input from the sensor 222 to output the sensor output image SOL Meanwhile, the sensor controller 224 may be coupled to the application processor 240 to provide the sensor output image SOI to the application processor 240.

The sensor output image SOI may have a low resolution in a preview mode of the camera image sensor 220, and may have a high resolution in a capture preparation mode of the camera image sensor 220. Here, it should be understood that a “resolution” of the sensor output image SOI is a term including a “pixel” of the sensor output image SOL a “size” of the sensor output image SOL a “capacity” of the sensor output image SOL a “sampling rate” of the sensor output image SOL etc. Meanwhile, a size of the sensor output image SOI having a low resolution may correspond to a display output size, and a size of the sensor output image SOI having a low resolution may be changed as the display output size is changed. For example, a size of the sensor output image SOI having a low resolution may be a VGA (640*480) size. On the other hand, a size of the sensor output image SOI having a high resolution may correspond to a reference or, alternatively, a predetermined size, and the reference or, alternatively, a predetermined size may be changed by a user. For example, a size of the sensor output image SOI having a high resolution may be a full-frame size (e.g., 5M (2608*1960), 8M (3264*2448), etc). As described above, an operation mode of the camera image sensor 220 may be changed between the preview mode and the capture preparation mode. In addition, the camera image sensor 220 may provide the sensor output image SOI having a different resolution according to an operation mode (i.e., the preview mode or the capture preparation mode) of the camera image sensor 220.

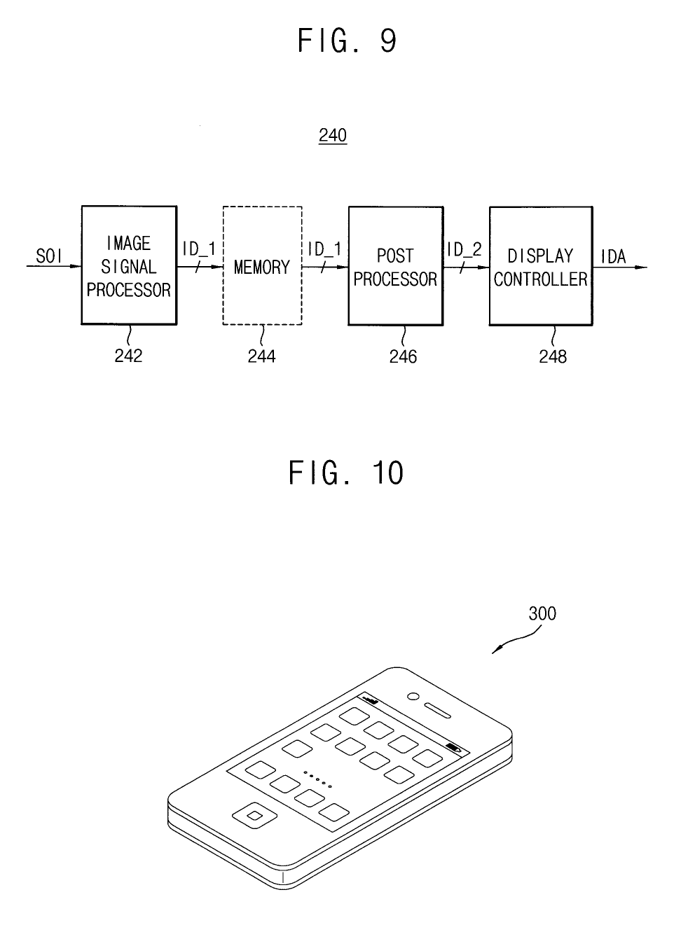

FIG. 9 is a block diagram illustrating an example of an application processor included in a mobile device of FIG. 7.

Referring to FIG. 9, the application processor 240 may include an image signal processor 242, a memory device 244, a post-processor 246, and a display controller 248. Although it is illustrated in FIG. 9 that the application processor 240 includes only components related to a function of a camera module (i.e., the image signal processor 242, the memory device 244, the post-processor 246, and the display controller 248), the components of the application processor 240 are not limited thereto. Thus, the application processor 240 may further include other components for supporting a plurality of other function circuits 280.

The image signal processor 242 may receive the sensor output image SOI output from the camera image sensor 220, and may generate first image data ID_1 by processing the sensor output image SOI. Substantially, the sensor output image SOI output from the camera image sensor 220 may not be recognized by a user. Thus, the image signal processor 242 may convert the sensor output image SOI into a signal that can be recognized by a user (i.e., the first image data ID_1). For example, the image signal processor 242 may generate the first image data ID_1 by controlling a color type, an image size, a frame speed, etc of the sensor output image SOI output from the image sensor unit 220. In FIG. 9, it is illustrated that the image signal processor 242 performs a function of a pre-processor. However, the pre-processor may be independently included in the application processor 240. In this case, the pre-processor may convert the first image data ID_1 into a signal that is suitable for the post-processor 246.

The memory device 244 may temporarily store the sensor output image SOI output from the image signal processor 242, and may output the sensor output image SOI to the post-processor 246. For example, the memory device 244 may include a volatile memory device such as a Dynamic Random Access Memory (DRAM) device, a Static Random Access Memory (SRAM) device, etc, and a non-volatile memory device such as an Erasable Programmable Read-Only Memory (EPROM) device, an Electrically Erasable Programmable Read-Only Memory (EEPROM) device, a flash memory device, etc. The memory device 244 may perform a buffer-function. In some example embodiments, the memory device 244 may not be included in the application processor 240 according to required conditions. The post-processor 246 may generate second image data ID_2 by post-processing the first image data ID_1 output from the image signal processor 242. That is, the post-processor 246 may convert the first image data ID_1 (i.e., input from the image signal processor 242 or the pre-processor) into the second image data ID_2 that can be displayed on a display device by the display controller 248. Next, the display controller 248 may display the second image data ID_2 as the image data IDA on the display device.

The image signal processing unit 240 may output the image data IDA by processing the sensor output image SOI output from the camera image sensor 220. In some example embodiments, the image data IDA may be output based on various codec (e.g., JPEG, TIF, GIF, PCX, etc). In addition, the application processor 240 may perform an Auto Exposure (AE) processing, an Auto White Balance (AWB) processing, an Auto Focus (AF) processing, an output format processing, a color correction processing, a gamma correction processing, a shading compensation processing, etc for the sensor output image SOI. In some example embodiments, the camera image sensor 220 may be coupled to the application processor 240 using MIPI interface, I2C interface, etc.

FIG. 10 is a diagram illustrating an example in which a mobile device of FIG. 7 is implemented as a smart-phone.

Referring to FIG. 10, it is illustrated that the mobile device 200 is implemented as a smart phone 300. However, the mobile device 200 may also be implemented as a cellular phone, a digital camera, a camcorder, etc. In other words, the mobile device 200 may be implemented as an electric device having a camera module. As described above, the mobile device 200 may perform various functions according to a mobile convergence trend. For example, the smart phone 300 may perform a camera function although a main function of the smart phone 300 is a communication function. To perform the camera function, the smart phone 300 may include the camera module having the camera image sensor 220, the application processor 240, and the display device 260. When an operation mode of the camera image sensor 220 is changed between a preview mode and a capture preparation mode, the mobile device 200 may change an interface setting value between the application processor 240 and the camera image sensor 220 at a reference or, alternatively, a predetermined time point. As a result, the mobile device 200 may prevent a user from recognizing a resolution change (i.e., a size change) of the sensor output image output from the camera image sensor 220. In addition, the mobile device 200 may prevent unnecessary power consumption by maintaining the preview mode as a default mode for the camera image sensor 220.

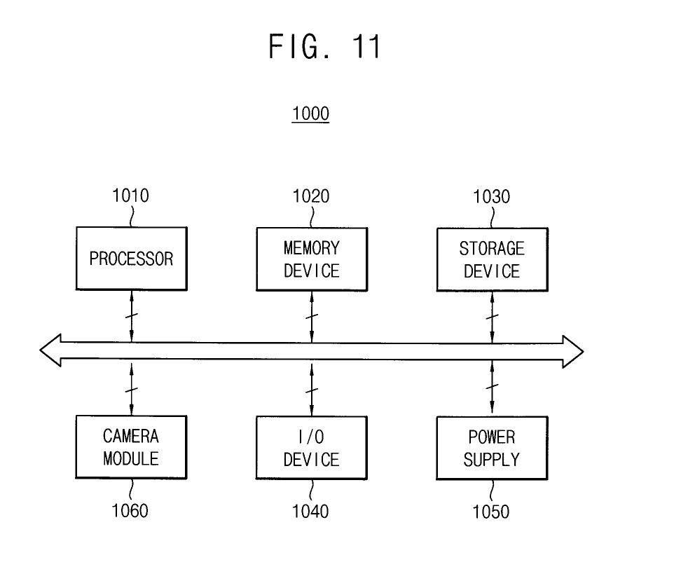

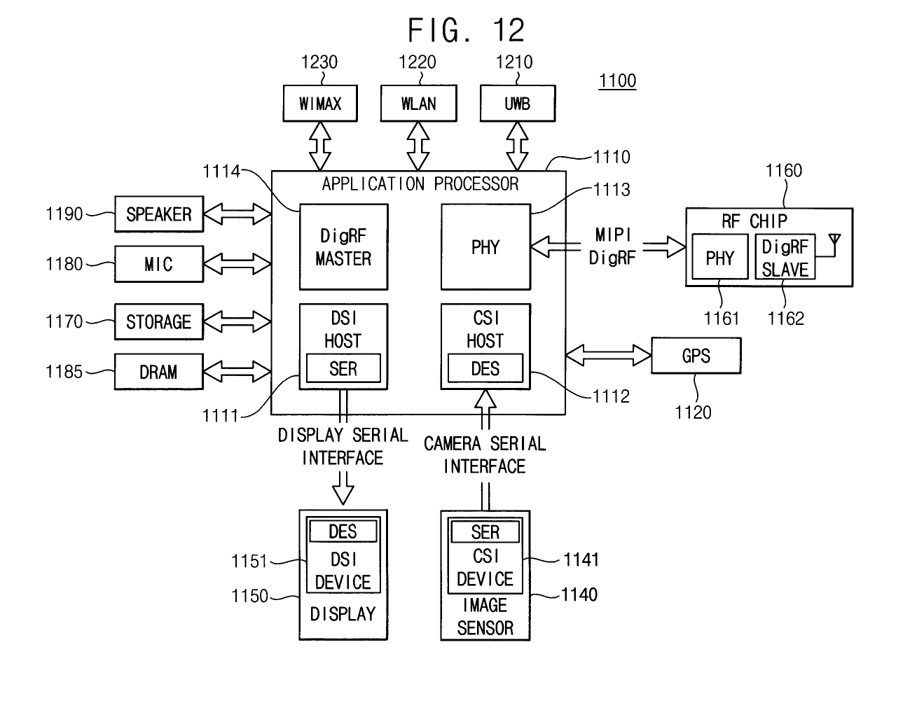

FIG. 11 is a block diagram illustrating an electric device employing a method of changing an operation mode of a camera image sensor according to example embodiments.

Referring to FIG. 11, the electric device 1000 may include a processor 1010, a memory device 1020, a storage device 1030, an input/output (I/O) device 1040, a power supply 1050, and a camera module 1060. As not illustrated in FIG. 11, the electric device 1000 may further include a plurality of ports for communicating a video card, a sound card, a memory card, a universal serial bus (USB) device, other electric devices, etc.

The processor 1010 may perform various computing functions. The processor 1010 may be a micro-processor, a central processing unit (CPU), etc. The processor 1010 may be coupled to the memory device 1020, the storage device 1030, and the I/O device 1040 via an address bus, a control bus, a data bus, etc. In some example embodiments, the processor 1010 may be coupled to an extended bus such as a peripheral component interconnection (PCI) bus. The memory device 1020 may store data for operations of the electric device 1000. For example, the memory device 1020 may include a volatile semiconductor memory device such as a double data rate synchronous dynamic random access memory (DDR SDRAM) device, a dynamic random access memory (DRAM) device, a static random access memory (SRAM) device, a mobile DRAM, etc, and a non-volatile semiconductor memory device such as an erasable programmable read-only memory (EPROM) device, an electrically erasable programmable read-only memory (EEPROM) device, a flash memory device, a phase change random access memory (PRAM) device, a resistance random access memory (RRAM) device, a nano floating gate memory (NFGM) device, a polymer random access memory (PoRAM) device, a magnetic random access memory (MRAM) device, a ferroelectric random access memory (FRAM) device, etc.

The storage device 1030 may be a solid state drive (SSD) device, a hard disk drive (HDD) device, a CD-ROM device, etc. The I/O device 1040 may include an input device such as a keyboard, a keypad, a mouse, etc, and an output device such as a printer, a display device, etc. The power supply 1050 may provide a power for operations of the electric device 1000. The camera module 1060 may perform a camera function. For example, according to at least one example embodiment, the camera module may include the camera image sensor 220 and application processor 240 discussed above with reference to FIG. 7. The camera module 1060 may communicate with the processor 1010 via buses or other communication links. As described above, the camera module 1060 may include a camera image sensor, an application processor, and at least one display device. Here, the camera module 1060 may change an interface setting value between the application processor and the camera image sensor at a reference or, alternatively, a predetermined time point. As a result, the camera module 1060 may prevent a user from recognizing a resolution change (i.e., a size change) of the sensor output image output from the camera image sensor. In addition, the camera module 1060 may prevent unnecessary power consumption by maintaining the preview mode as a default mode for the camera image sensor.

In some example embodiments, the electric device 1000 may be implemented using various kinds of packages. For example, the packages may include package on package (PoP), a ball grid arrays (BGAs), chip scale packages (CSPs), plastic leaded chip carrier (PLCC), plastic dual in-line package (PDIP), die in waffle pack, die in wafer form, chip on board (COB), ceramic dual in-line package (CERDIP), plastic metric quad flat pack (MQFP), thin quad flat-pack (TQFP), small outline integrated circuit (SOIC), shrink small outline package (SSOP), thin small outline package (TSOP), thin quad flat-pack (TQFP), system in package (SIP), multi chip package (MCP), wafer-level fabricated package (WFP), wafer-level processed stack package (WSP), etc.

FIG. 12 is a block diagram illustrating an example of an interface used for an electric device of FIG. 11.

Referring to FIG. 12, the electric device 1100 may be implemented by a data processing device that uses, or supports a MIPI interface. The electric device 1100 may include an application processor 1110, an image sensor 1140, a display device 1150, etc. According to at least one example embodiment, the image sensor 1140 and application processor 1110 may have the same structure and manner of operation as that described above with reference to the camera image sensor 220 and the application processor 240, respectively. A CSI host 1112 of the application processor 1110 may perform a serial communication with a CSI device 1141 of the image sensor 1140 using a camera serial interface (CSI). In one example embodiment, the CSI host 1112 may include a light deserializer (DES), and the CSI device 1141 may include a light serializer (SER). A DSI host 1111 of the application processor 1110 may perform a serial communication with a DSI device 1151 of the display device 1150 using a display serial interface (DSI). In one example embodiment, the DSI host 1111 may include a light serializer (SER), and the DSI device 1151 may include a light deserializer (DES).

Further, the electric device 1100 may further include a radio frequency (RF) chip 1160. The RF chip 1160 may perform a communication with the application processor 1110. A physical layer (PHY) 1113 of the electric device 1100 and a physical layer (PHY) 1161 of the RF chip 1160 may perform data communications based on a MIPI DigRF. The application processor 1110 may further include a DigRF MASTER 1114 that controls the data communications of the PHY 1161. The electric device 1100 may include a global positioning system (GPS) 1120, a storage 1170, a MIC 1180, a DRAM device 1185, and a speaker 1190. In addition, the electric device 1100 may perform communications using an ultra wideband (UWB) 1210, a wireless local area network (WLAN) 1220, a worldwide interoperability for microwave access (WIMAX) 1230, etc. However, the structure and the interface of the electric device 1100 are not limited thereto.

Example embodiments may be applied to a camera module and an electric device (e.g., a mobile device) having the camera module. For example, example embodiments may be applied to an electric device such as a computer, a laptop, a digital camera, a 3D camera, a video camcorder, a cellular phone, a smart phone, a personal digital assistant (PDA), a portable multimedia player (PMP), a navigation system, a monitoring system, an auto focusing system, a video phone, a digital television, etc.

Example embodiments having thus been described, it will be obvious that the same may be varied in many ways. Such variations are not to be regarded as a departure from the intended spirit and scope of example embodiments, and all such modifications as would be obvious to one skilled in the art are intended to be included within the scope of the following claims.

What is claimed is:

1. A method of changing an operation mode of a camera image sensor, the method comprising:
controlling an application processor to output a resolution change request signal to the camera image sensor when an operation mode change signal is generated while the camera image sensor outputs a first sensor output image;
controlling the camera image sensor to prepare a resolution change operation in response to the resolution change request signal, to output an interrupt signal to the application processor when the resolution change operation is prepared, to perform the resolution change operation after the first sensor output image is output, and to output a second sensor output image when the resolution change operation is completed; and
controlling the application processor to change an interface setting value in response to the interrupt signal, and to receive the second sensor output image based on the changed interface setting value.

2. The method of claim 1, wherein controlling an application processor to output a resolution change request signal includes transmitting the resolution change request signal based on an inter-integrated circuit (I2C) interface.

3. The method of claim 2, wherein the first sensor output image and the second sensor output image are transmitted based on at least one of the MIPI interface, the ITU-R BT.601 interface, the ITU-R BT.656 interface, and the ITU-R BT.709 interface.

4. The method of claim 1, wherein the first sensor output image corresponds to a sensor output image having a low resolution, and the second sensor output image corresponds to a sensor output image having a high resolution.

5. The method of claim 4, further comprising:
changing a size of the first sensor output image as the display output size is changed; and
changing a size of the second sensor output image by a user.

6. The method of claim 4, further comprising:
receiving the first sensor output image at the application processor in a preview mode of the camera image sensor; and
receiving the second sensor output image at the application processor in a capture preparation mode of the camera image sensor.

7. The method of claim 6, wherein the operation mode change signal corresponds to an auto-focus start signal for performing a focusing operation.

8. The method of claim 6, wherein the operation mode change signal corresponds to a smile detection signal for performing a smile detecting operation.

9. The method of claim 6, wherein the operation mode change signal corresponds to a face detection signal for performing a face detecting operation.

10. The method of claim 6, wherein the operation mode change signal corresponds to a first external input signal for changing the operation mode of the camera image sensor from the preview mode to the capture preparation mode.

11. The method of claim 1, wherein the first sensor output image corresponds to a sensor output image having a high resolution, and the second sensor output image corresponds to a sensor output image having a low resolution.

12. The method of claim 11, further comprising:
changing a size of the first sensor output image, the size of the first sensor output image being changed by a user; and
changing a size of the second sensor output image as the display output size is changed.

13. The method of claim 11, further comprising:
receiving the first sensor output image at the application processor in a capture preparation mode of the camera image sensor; and
receiving the second sensor output image at the application processor in a preview mode of the camera image sensor.

14. The method of claim 13, wherein the operation mode change signal corresponds to a capture completion signal for indicating that an image capture operation of the first sensor output image is completed.

15. The method of claim 13, wherein the operation mode change signal corresponds to a second external input signal for changing the operation mode of the camera image sensor from the capture preparation mode to the preview mode.

16. A method of changing an operation mode of a camera image sensor in a device including the camera sensor and an application processor, the method comprising:
generating an operation mode change signal while the camera image sensor outputs a first image having a first resolution;
outputting a resolution change request signal from the application processor to the camera image sensor in response to the operation mode change signal;
changing a resolution of the camera image sensor from the first resolution to a second resolution in response to the resolution change request signal, the second resolution being higher than the first resolution; and
outputting an interrupt signal and a second image having the second resolution from the camera image sensor to the application processor;
receiving the second image at the application processor based on the interrupt signal.

17. The method of claim 16, further comprising:
changing an interface value at the application processor based on the interrupt signal, the receiving the second image at the application processor including switching from receiving the first image to receiving the second image based on the interface value.

18. The method of claim 16, wherein the generating the operation mode change signal includes generating the operation mode change signal based on at least one of an autofocus operation, a smile detection operation, and a face detection operation.
